(19) United States
(12) Patent Application Publication
(10) Pub. No.: US 2022/0076263 A1
(43) Pub. Date: Mar. 10, 2022

(54) CONFIGURABLE DATA CONTAINER FOR FRAUD DETECTION SYSTEM

(71) Applicant: MASTERCARD TECHNOLOGIES CANADA ULC, Vancouver (CA)

(72) Inventors: Andrian Sevastyanov, Vancouver (CA); Yi Wei Tseng, Vancouver (CA); Perry McGee, Vancouver (CA); Sunita Khera, Delta (CA)

(21) Appl. No.: 17/016,518

(22) Filed: Sep. 10, 2020

(51) Int. Cl. G06Q 20/40; G06F 21/62; G06F 16/21

(52) U.S. Cl. CPC G06Q 20/4016; G06Q 20/4093; G06F 16/212; G06F 21/6227; G06F 21/6272

(57) ABSTRACT

Systems, methods, and non-transitory computer readable media for generating a configurable data container that includes a first data field, exporting the configurable data container for use by a client-side device, receiving a modification to the configurable data container, automatically binding the second data field to a second data path for retrieval of a second data value to be used in a second fraud detection rule, generating an updated configurable data container, and exporting the updated configurable data container for use by the client-side device. The first data field corresponds to a first data path for retrieval of a first data value to be used in a first fraud detection rule. The configurable data container includes a server-side schema and a client-side schema. Each of the server-side schema and the client-side schema is configured to validate a first input data value corresponding to the first data field.

### FIELD

Embodiments described herein relate to a fraud detection system.

### BACKGROUND

Detecting fraudulent web-based activity can be a difficult task. As fraudulent or malicious attacks become more and more sophisticated, more sophisticated and adaptable techniques for detecting the fraudulent activity are desired. However, there are a number of difficulties associated with fraud detection in a web-based environment. Whether working with a website or through a mobile-platform, fraud detection is dependent upon data that is collected from the website or mobile platform. The data is, for example, customer data that can be used to detect anomalous or fraudulent activity. The customer data is provided to the fraud detection system through data containers or data contracts. Data contracts include, for example, a collection of JavaScript Object Notation (“JSON”) classes. The JSON classes include a collection of data points (e.g., address, credit card number, IP address, user agent, device identification, device fingerprint, endpoint, account, input characteristics, session, etc.) associated with a user and/or device.

When modifying, and particularly when expanding, the data that is collected using data contracts, software on both the server-side of the fraud detection system and the client-side of the fraud detection system conventionally required recoding. For example, when adding new data points to the fraud detection system for a particular client, client libraries (software development kits [“SDKs”]) are updated to include new data contracts and/or new fields, structures, or validation rules for existing JSON classes. The server-side of the fraud detection system is then updated to receive the new data points, and fraud detection rule bindings are updated to expose the new data points to the system. The customer then integrates the new SDKs into the client-side system to start providing the new data points. The customer's software development team would typically vet the new SDKs to ensure quality standards are met, and then the development team updates their software code to be able to send the new data points. The customer's updated system is deployed following completion of operations and quality assurance measures. After the client-side system has been updated and can provide the new data points to the fraud detection system, fraud detection rules for risk assessment, historical tracking, and pattern analysis are updated utilizing the new data points.

Such an update process is complex, time intensive, dependent on multiple development teams, and is beholden to various software release schedules.

### SUMMARY

Embodiments described herein provide a dynamic data contract configuration process that eliminates several of the steps outlined above. As a result, when a customer wants to send additional, new data points to the fraud detection system, a configurable data contract is created or updated on the server-side to include new data fields and JSON schemas for structuring and formatting data. The new or updated data contract can be downloaded by the customer, and the JSON schemas of the data contract are loaded into the client library. The JSON schemas are used to perform basic data validation and data structuring automatically. After, for example, the new data points are sent to the server-side of the fraud detection system, fraud detection rules for risk assessment, historical tracking, pattern analysis, etc., can be updated utilizing the new data points. Each data point corresponds to data that the system 100 will need to retrieve from a data source in order to execute the rules and policies that have been generated for a particular website. Each unique data point has a corresponding data path that allows the system 100 to retrieve data from the corresponding data source.

Embodiments described herein provide a fraud detection system. The fraud detection system includes a server operable to detect fraud based on data received from a client-side device. The server includes a processor and a memory. The server is configured to generate a configurable data container that includes a first data field. The first data field corresponds to a first data path for retrieval of a first data value to be used in a first fraud detection rule. The configurable data container includes a server-side schema and a client-side schema. Each of the server-side schema and the client-side schema is configured to validate a first input data value corresponding to the first data field. The server is also configured to export the configurable data container for use by the client-side device and receive a modification to the configurable data container. The modification includes a second data field to be associated with the configurable data container. The server is also configured to automatically bind the second data field to a second data path for retrieval of a second data value to be used in a second fraud detection rule and generate an updated configurable data container. The updated configurable data container includes an updated server-side schema and an updated client-side schema. Each of the updated server-side schema and the updated client-side schema is configured to validate a second input data value corresponding to the second data field. The server is also configured to export the updated configurable data container for use by the client-side device.

Embodiments described herein provide a computer-implemented fraud detection method. The method includes generating a configurable data container that includes a first data field. The first data field corresponds to a first data path for retrieval of a first data value to be used in a first fraud detection rule. The configurable data container includes a server-side schema and a client-side schema. Each of the server-side schema and the client-side schema is configured to validate a first input data value corresponding to the first data field. The method also includes exporting the configurable data container for use by a client-side device and receiving a modification to the configurable data container. The modification includes a second data field to be associated with the configurable data container. The method also includes automatically binding the second data field to a second data path for retrieval of a second data value to be used in a second fraud detection rule, and generating an updated configurable data container. The updated configurable data container includes an updated server-side schema and an updated client-side schema. Each of the updated server-side schema and the updated client-side schema is configured to validate a second input data value corresponding to the second data field. The method also includes exporting the updated configurable data container for use by the client-side device.

Embodiments described herein provide a non-transitory computer readable medium including computer executable instructions stored in the computer readable medium for controlling a device to generate a configurable data container that includes a first data field, export the configurable data container for use by a client-side device, receive a modification to the configurable data container, automatically bind the second data field to a second data path for retrieval of a second data value to be used in a second fraud detection rule, generate an updated configurable data container, and export the updated configurable data container for use by the client-side device. The first data field corresponds to a first data path for retrieval of a first data value to be used in a first fraud detection rule. The configurable data container includes a server-side schema and a client-side schema. Each of the server-side schema and the client-side schema is configured to validate a first input data value corresponding to the first data field. The modification includes a second data field to be associated with the configurable data container. The updated configurable data container includes an updated server-side schema and an updated client-side schema. Each of the updated server-side schema and the updated client-side schema is configured to validate a second input data value corresponding to the second data field.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers” and “computing devices” described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

Functionality described herein as being performed by one component may be performed by multiple components in a distributed manner. Likewise, functionality performed by multiple components may be consolidated and performed by a single component. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a fraud prevention system, according to embodiments described herein.

FIG. 2 illustrates a server-side processing device of the fraud prevention system of FIG. 1, according to embodiments described herein.

FIG. 3 illustrates a JavaScript Object Notation (“JSON”) class hierarchy, according to embodiments described herein.

FIG. 4 is a high-level illustration of the use of configurable data contracts, according to embodiments described herein.

FIG. 5 is a process for implementing a configurable data contract, according to embodiments described herein.

FIG. 6 is a flow diagram for configurable data contracts, according to embodiments described herein.

FIG. 7 is a process for updating configurable data contracts, according to embodiments described herein.

### DETAILED DESCRIPTION

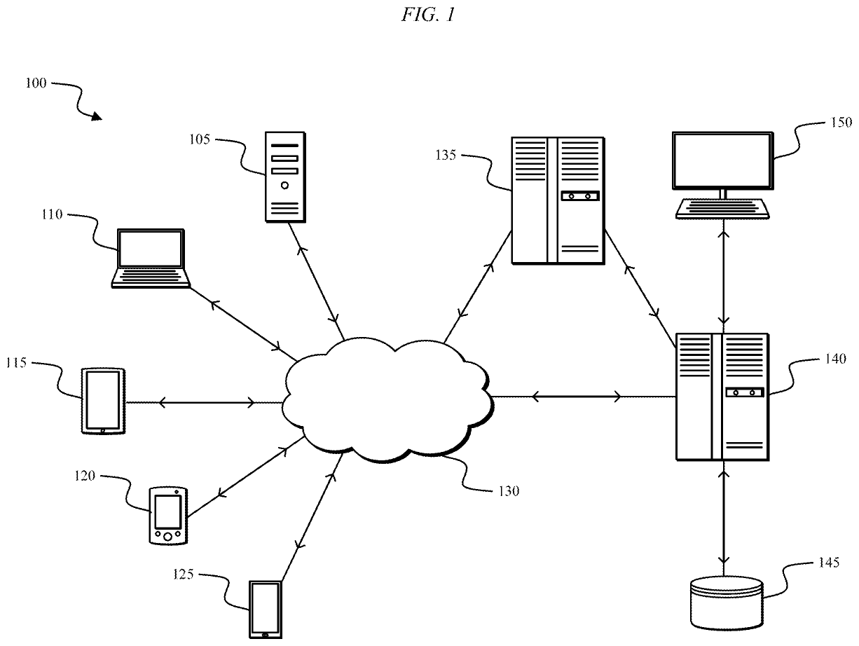

FIG. 1 illustrates a fraud prevention system 100 that includes a configurable data container or configurable data contract (“CDC”) for adding or modifying data points used in, for example, a fraud risk assessment. The system 100 includes a plurality of client-side devices 105-125, a network 130, a first server-side mainframe computer or server 135, a second server-side mainframe computer or server 140, a database 145, and a server-side user interface 150 (e.g., a workstation). The plurality of client-side devices 105-125 include, for example, a personal, desktop computer 105, a laptop computer 110, a tablet computer 115, a personal digital assistant (“PDA”) (e.g., an iPod touch, an e-reader, etc.) 120, and a mobile phone (e.g., a smart phone) 125. Each of the devices 105-125 is configured to communicatively connect to the server 135 or the server 140 through the network 130 and provide information to the server 135 or server 140 related to, for example, attributes or values for attributes of the devices 105-125. Attributes of the devices 105-125 include, for example, user agent, operating system, account identifier (“ID”), location, time of day, etc. The attributes or values for attributes related to the devices 105-125 can be provided to the server 135 or the server 140 through an application program installed on the devices 105-125. Attribute information received from the devices 105-125 at the server 135 or server 140 can be stored in the database 145.

The network 130 is, for example, a wide area network (“WAN”) (e.g., a TCP/IP based network), a local area network (“LAN”), a neighborhood area network (“NAN”), a home area network (“HAN”), or personal area network (“PAN”) employing any of a variety of communications protocols, such as Wi-Fi, Bluetooth, ZigBee, etc. In some implementations, the network 130 is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

The connections between the devices 105-125 and the network 130 are, for example, wired connections, wireless connections, or a combination of wireless and wired connections. Similarly, the connections between the server 135 or the server 140 and the network 130 are wired connections, wireless connections, or a combination of wireless and wired connections.

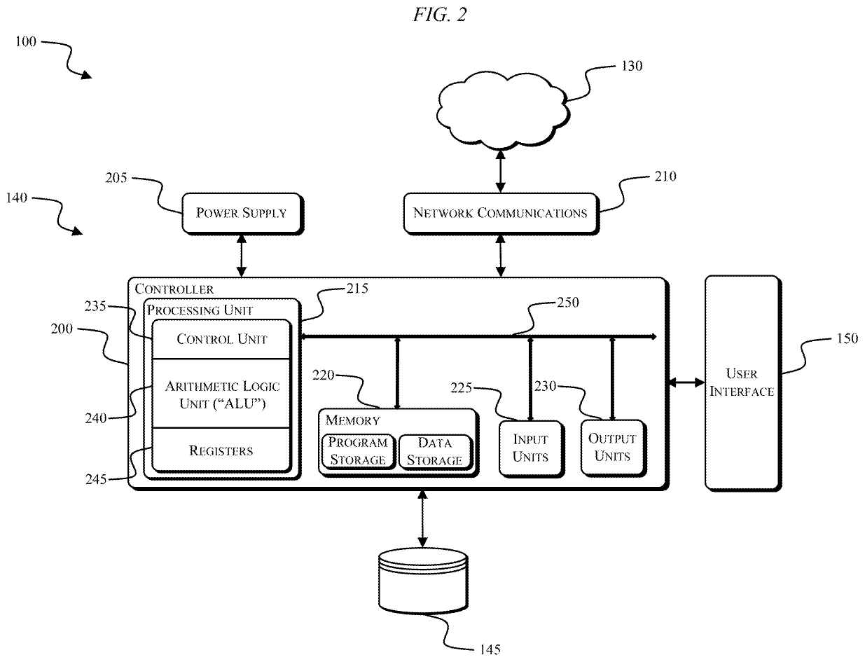

FIG. 2 illustrates the server-side of the system 100 with respect to the server 140. The server 140 is electrically and/or communicatively connected to a variety of modules or components of the system 100. For example, the illustrated server 140 is connected to the database 145 and the user interface 150. The server 140 includes a controller 200, a power supply module 205, and a network communications module 210. The controller 200 includes combinations of hardware and software that are operable to, for example, create, read, update, and/or delete configurable data contracts. The controller 200 includes a plurality of electrical and electronic components that provide power, operational control, and protection to the components and modules within the controller 200 and/or the system 100. For example, the controller 200 includes, among other things, a processing unit 215 (e.g., a microprocessor, a microcontroller, an electronic controller, and electronic processor, or another suitable programmable device), a memory 220, input units 225, and output units 230. The processing unit 215 includes, among other things, a control unit 235, an arithmetic logic unit (“ALU”) 240, and a plurality of registers 245 (shown is a group of registers in FIG. 2) and is implemented using a known architecture. The processing unit 215, the memory 220, the input units 225, and the output units 230, as well as the various modules connected to the controller 200 are connected by one or more control and/or data buses (e.g., common bus 250). The control and/or data buses are shown schematically in FIG. 2 for illustrative purposes.

The memory 220 is a non-transitory computer readable medium and includes, for example, a program storage area and a data storage area. The program storage area and the data storage area can include combinations of different types of memory, such as read-only memory (“ROM”), random access memory (“RAM”) (e.g., dynamic RAM [“DRAM”], synchronous DRAM [“SDRAM”], etc.), electrically erasable programmable read-only memory (“EEPROM”), flash memory, a hard disk, an SD card, or other suitable magnetic, optical, physical, electronic memory devices, or other data structures. The processing unit 215 is connected to the memory 220 and executes software instructions that are capable of being stored in a RAM of the memory 220 (e.g., during execution), a ROM of the memory 220 (e.g., on a generally permanent basis), or another non-transitory computer readable data storage medium such as another memory or a disc.

In some embodiments, the controller 200 or network communications module 210 includes one or more communications ports (e.g., Ethernet, serial advanced technology attachment [“SATA”], universal serial bus [“USB”], integrated drive electronics [“IDE”], etc.) for transferring, receiving, or storing data associated with the system 100 or the operation of the system 100. In some embodiments, the network communications module 210 includes an application programming interface (“API”) for the server 140. Software included in the implementation of the system 100 can be stored in the memory 220 of the controller 200. The software includes, for example, firmware, one or more applications, program data, filters, rules, one or more program modules, and other executable instructions. The controller 200 is configured to retrieve from memory and execute, among other things, instructions related to the implementation and modification of CDCs described herein.

The power supply module 205 supplies a nominal AC or DC voltage to the controller 200 or other components or modules of the system 100. The power supply module 205 is powered by, for example, mains power having nominal line voltages between 100V and 240V AC and frequencies of approximately 50-60 Hz. The power supply module 205 is also configured to supply lower voltages to operate circuits and components within the controller 200 or system 100.

The user interface 150 includes a combination of digital and analog input or output devices required to achieve a desired level of control and monitoring for the system 100. For example, the user interface 150 includes a display (e.g., a primary display, a secondary display, etc.) and input devices such as a mouse, touch-screen displays, a plurality of knobs, dials, switches, buttons, etc. The display is, for example, a liquid crystal display (“LCD”), a light-emitting diode (“LED”) display, an organic LED (“OLED”) display, or the like.

To make the fraud detection system 100 more flexible, the system 100 includes configurable data containers or configurable data contracts (“CDCs”) as, for example, a JavaScript Object Notation (“JSON”) class. For example, when a customer wants to send additional, new data points to the fraud detection system 100, a CDC is created or updated by the server 140 to include new data fields and schemas (e.g., JSON schemas) for structuring and formatting customer data. The new or updated CDC can be downloaded by the customer, and the schemas of the CDC are loaded into the client library (e.g., on server 135). In some embodiments, the CDC takes a JSON schema path as a constructor argument. The CDC includes rules for setting key-value pairs and can perform validation of a data structure against the JSON schema. The JSON schema used for validating customer data uses, for example, a unique identification (“ID”) to track changes made to the CDC over time (e.g., keep track of difference CDC versions). The path of the JSON schema can be passed to the constructor of the CDC class. In some embodiments, JSON schemas are loaded from an HTTP endpoint.

When the customer data is transmitted or sent to the server 140, the server 140 performs a similar schema validation (e.g., JSON schema validation) using a server-side schema that is a superset of the client-side schema (e.g., including meta data related to the use of the CDC). For example, in some embodiments, server-side JSON schema include information and structures for automatically binding the configured data values to the server 140's fraud rules engine and exposes the configured data values to a rule creation engine without requiring any further code changes or configuration. The rules engine includes a registry class that contains and provides information related to the data points (e.g., address, credit card number, IP address, user agent, device identification, device fingerprint, endpoint, account, input characteristics, session, etc.) that are available. Multiple data points can be associated with each rule and a plurality of rules can each include multiple data points. In some embodiments, a data point can be defined or configured but not used in a rule.

The information related to the data points is available at both the time that fraud detection rules are created (e.g., for autocomplete and validation purposes) and at rule deployment for validation and transpilation into source code (e.g., PHP). In some embodiments, the registry class is configured to have access to the schemas (e.g., JSON schemas) that are generated for each CDC that is deployed. Based on each of those schemas, additional data points are returned when data is requested. The system 100 uses the schemas to validate whether each data point is available when the CDC is deployed. Following validation, the registry class exposes the CDC data points to the rules engine (e.g., <CDCActionDataName>.<fieldNameFromTheCDCActionData> or CustomerData.phoneNumber). In some embodiments, accepted data values can be strings, numeric, Boolean values, and/or nested objects.

The CDC is configured using, for example, the user interface 150 connected to the server 140. A variety of configuration end points for the CDC are used to customize the CDC. For example, the configuration endpoints include actions such as create group, view group, view groups, view field types, edit group, create action data, edit action data, configure group to website, deploy group, deploy website, download by website, download by website by group, download by website by CDC, etc.

These configuration endpoints allow the server 140 to create, read, update, and delete all aspects of a CDC. The configuration endpoints also allow the server 140 to deploy changes to the CDC that automatically generate two sets of schemas. First, a client-side schema is generated that can be used to guide customers and validate client-side data. Second, a server-side schema is used by the server 140 to determine the customer data that can be sent from the client-side and how the customer data should be exposed to the server 140 (e.g., a rule or scripting engine). In some embodiments, the data structure updates occur on the server-side without requiring a corresponding software update on the client-side. The schemas are created when CDC deployment is initiated. Initially, the system 100 looks for CDCs and the data points or fields associated with those CDCs. Each CDC results in a schema file (e.g., a JSON schema file) that is synchronized to the server 140 and that schema file becomes available for download or forwarding to a client. The schema file is used by the client in a client library to automatically detect whether the client has correctly named the fields for a particular CDC action data (e.g., was a typographical error made that causes the schema to fail validation of a data point).

The configuration endpoints also allow the server 140 to define custom data field containers on a per-customer basis, define custom fields on a per-customer basis, and define which data fields can be enhanced by data object API add-ons (e.g., non-session-level data, such as counters, counter associations [associated with other data points], lists [manually or automatically managed], and reputation).

Data points available to the server 140 are, for example, exposed using the data objects API via paths that are grouped into anchors. For example, fraud detection is achieved using a flexible scripting language and syntax that simplifies the generation of fraud detection rules. The rules are structured as conditional IF-THEN statements that include data objects referred to as anchors and add-ons. The anchors and add-ons used to generate the rules also correspond to a distinct data path for the retrieval data from any of a variety of data sources. The rules are then executed in real-time in the environment to detect potential fraudulent activity.

Using CDCs, new anchors do not need to be defined in the server 140's code (e.g., hard coded). Instead, a new CDC action data class is created that contains fields based on configuration during a given fraud score request. During a fraud score request, zero to M instances of the CDC action data class can be instantiated. Each instance of the CDC action data class corresponds to one configured CDC. The logic associated with the CDC action data class permits members of the class to read and parse server-side JSON schema configurations, obtain data points from API parameters and session storage, and permit retrieval of data points and enhanced data points (e.g., enhanced with add-ons) from the fraud detection system 100.

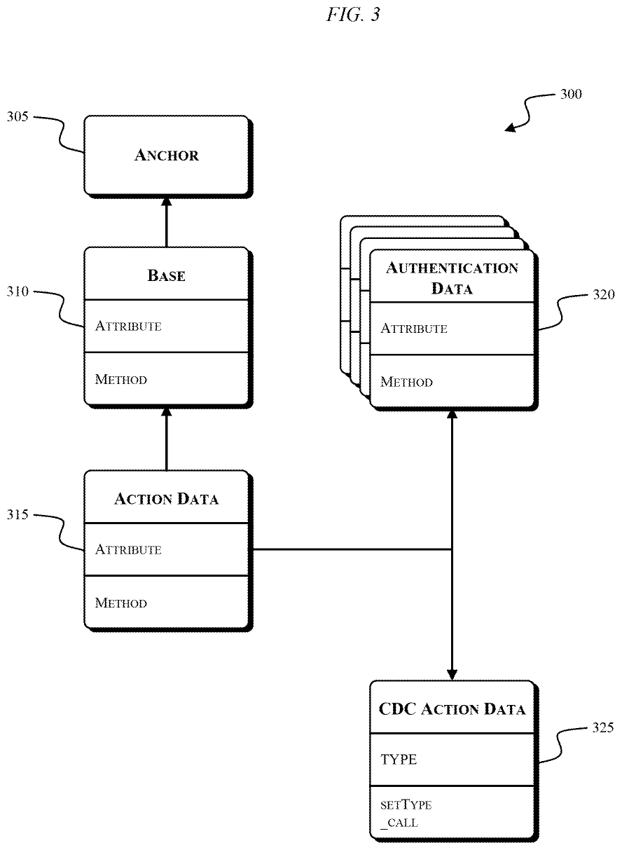

The server-side schemas are stored at the server 140. The code in the CDC action data class opens the schema files and parses them to determine what fields are available for a particular CDC action data object. Data containers are passed to the CDC action data class related to parsed input action data for a current request and parsed action data for a particular session (e.g., based on session ID). This data persists in the server 140 with a configured time-to-live. In some embodiments, the data can be viewed from a high-level with respect to four dimensions. First, independent activity for each data point (e.g., anchor) is recorded across three time dimensions: (1) current or session (highest resolution); (2) recent (e.g., within the past seven days) using an existing counter mechanism; and (3) historical (e.g., within the past twelve months) using an existing counter mechanism having different time bucket resolutions. Counters are used to monitor each data point across the three time dimensions (i.e., current, recent, historical). A counter is a tool used to count actions or properties of a request (e.g., anchors and add-ons) for specific time bucket ranges. The counters provide temporal filters and enable aggregate questions that can be asked of a particular data point. Second, pairwise associations between anchors are retained in a probabilistic manner across the same time dimensions as the independent anchor activity and using the existing counter mechanism. Third, local reputation (e.g., list status) using a white list or a black list are retained for each anchor. Fourth, global or cloud reputation based on activity for each anchor across all users of the system 100 (e.g., data for multiple clients). FIG. 3 illustrates how the CDC action data class fits into a class hierarchy that includes anchors 305, base data 310, action data 315, authentication data 320, and the CDC action data 325.

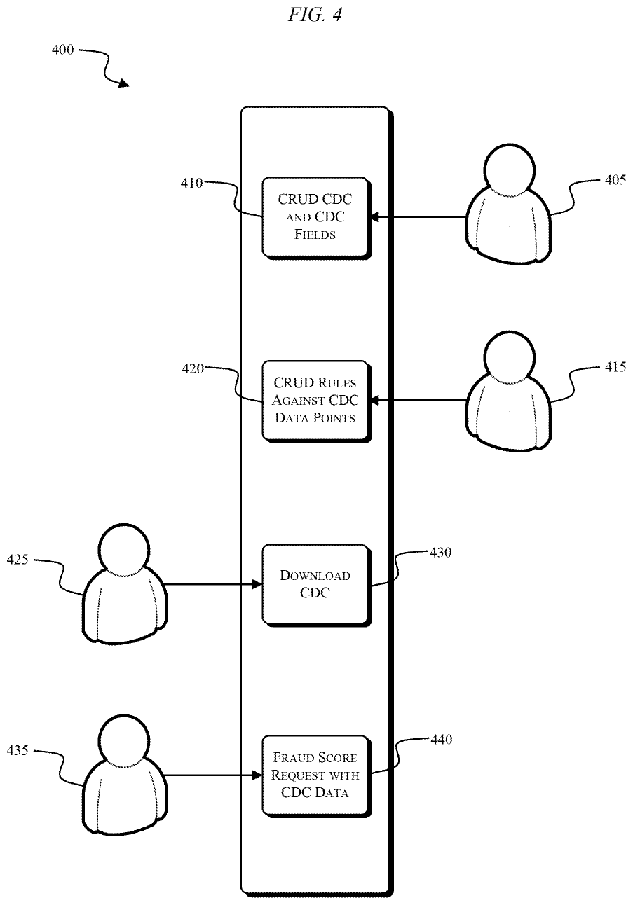

FIG. 4 illustrates a high-level diagram 400 of the use of CDCs between a server-side and a client-side of the fraud detection system 100. For example, a user 405 or the server 140 creates, reads, updates, and deletes a CDC and CDC data fields as needed at 410. Another user 415 or the server 140 then creates, reads, updates, and deletes fraud detection rules that check against data points configured using the CDC at 420. The CDC and associated schemas are then exported and made available to a customer 425 or the server 135 at 430. The CDC and associated schemas are added to the customer's client library (e.g., on server 135). Another user 435 or the server 135 then sends a fraud assessment request to the server 140 at 440. The fraud assessment request includes the data fields defined in the CDC.

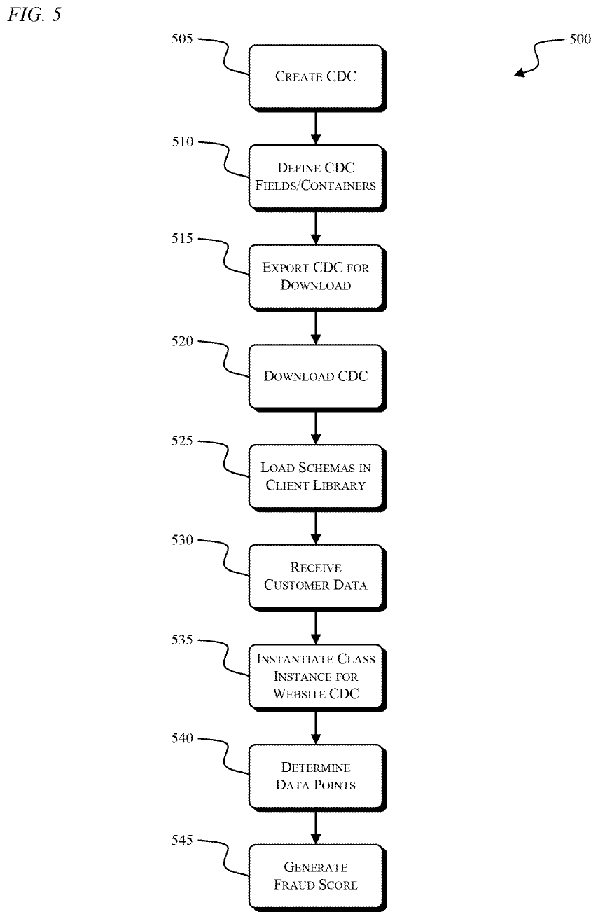

FIG. 5 illustrates a more detailed process 500 for implementing CDCs. The process 500 begins with a CDC being created (STEP 505). One or more data fields and/or data containers and schemas are defined for the CDC (STEP 510). After the CDC configuration is completed, the CDC is exported or otherwise made available for download by a customer (STEP 515). The CDC can then be downloaded by the customer (e.g., for a particular website) (STEP 520) and the schemas from the CDC are loaded into the client library (e.g., on server 135) (STEP 525). At STEP 530, the server 140 receives customer data using the CDC as part of, for example, a fraud risk assessment request. An instance of the CDC action data class is instantiated for the CDC (STEP 535). The data points associated with the CDC are determined (STEP 540) and provided to the server 140 (e.g., a fraud detection engine) for completing the fraud risk assessment to generate a fraud score (STEP 545).

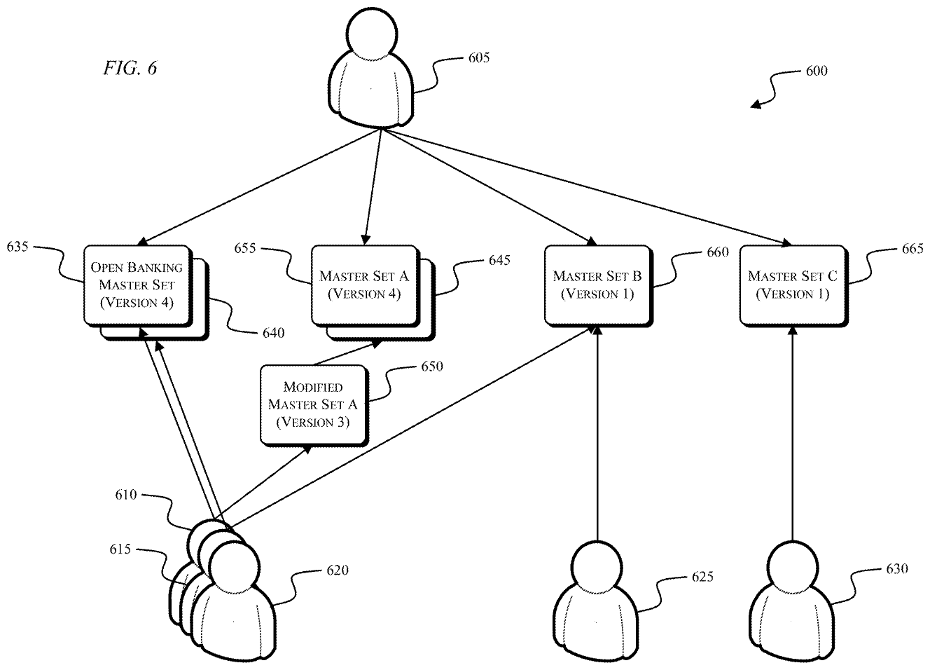

FIG. 6 illustrates a more complex set of CDCs 600. A server-side entity 605 is responsible for creating or generating a plurality of CDCs. The CDCs are made available to a variety of entities. For example, the CDCs can be made available to a set of open banking customers 610, 615, 620, a second customer 625, and a third customer 630. The set of CDCs 600 begins, for example, with a single master CDC (e.g., a particular set of data fields, field containers, and set of schemas). For this initial master CDC, the version number is set to zero, a list or registry of websites that use the master CDC is empty, and a list of websites that inherit properties and parameters from the CDC is also empty. For each website that will receive the master CDC, a new copy of the master CDC is attached to a particular client website id (e.g., URL, IP address, etc.). The new CDC for the particular client website can be saved as version 1 of the CDC. As shown in FIG. 6, multiple versions of the original master CDC can be promulgated and used by the customers 610-630. For example, a first group of open banking CDCs includes an open banking master set (version 4) 635 and an open banking master set (version 3) 640. In some embodiments, only the two most recent versions of the CDC in a particular group are available for use (e.g., to account for delays in adopting updates on the client-side). In other embodiments, all or a different number of versions of the CDC in the particular group are available for use. The new versions of the CDC can be generated by the server-side entity 605 separately or based on modifications received/requested from a customer 610-630. In some embodiments, a user interface is available to customers to directly create or update new CDCs that can be downloaded and loaded into their client libraries.

In the example illustrated in FIG. 6, the first open banking customer 610 is using the open banking master set (version 4) 635, and the second open banking customer 615 is using the open banking aster set (version 3) 640. The first open banking customer 610 has also modified master set A (version 3), which results in the creation of a new version of the master set A—master set A (version 4). Additionally, multiple different users or clients can have access to the same CDC. For example, the second open banging client 615 uses both the open banking master set (version 3) and the master set B (version 1). When multiple different customers (e.g., multiple different customer websites) use the same master set, the list or registry of websites that use that master set is updated to include each website. For example, the master set B (version 1) is also used by the second customer 625. In the example illustrated in FIG. 6, the master set C (version 1) is only used by the second customer 630. In some embodiments, the CDCs 635-665 are capable of being grouped together and provided to a customer. In some embodiments, customers only have access to the CDCs that were specifically provisioned to them when the CDCs were exported.

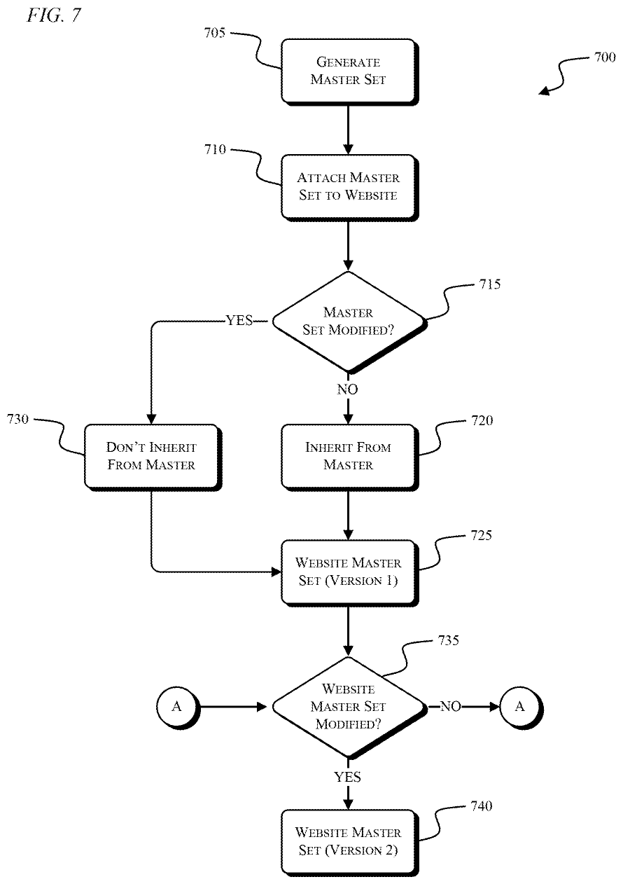

FIG. 7 illustrates a process 700 for updating a CDC. The process 700 begins with a master set or master CDC being generated (e.g., including data fields, field containers, a set of JSON schemas, etc.) (STEP 705). The master CDC is attached to a website (e.g., based on website ID) (STEP 710), and the server 140 determines whether any modifications have been made to the master CDC (STEP 715). If no modifications have been made to the master CDC, a copy of the master CDC is made and it inherits the properties and parameters associated with the master CDC (STEP 720) and the new copy of the master CDC is stored as the website's master set (version 1) (STEP 725). The list or registry of websites that inherit the properties and parameters from the CDC is also updated.

If modifications were made to the master CDC (e.g., modifications that are specific to the website), a copy of the master CDC is made that doesn't inherit the properties and parameters associated with the master CDC (STEP 730). Rather, the copy of the master CDC will be a standalone master set that is separate from the original master CDC. The new copy of the master CDC is then stored as the website's master set (version 1) (STEP 725). At STEP 735, the server 140 determines whether the website's master set (version 1) has been modified (e.g., on either the server-side or client-side). If, the website's master set has not been modified, the process 700 remains at STEP 735. If, at STEP 735, the website's master CDC has been modified, a new version of the master set is stored as the website's master set (version 2) (STEP 740). The website's master set (version 2) includes the modifications to the website's master set (version 1) (e.g., an added data field that can be used for fraud detection).

Thus, embodiments described herein provide, among other things, a fraud prevention system including configurable data contracts. Various features and advantages are set forth in the following claims.

What is claimed is:

1. A fraud detection system comprising:
a server operable to detect fraud based on data received from a client-side device, the server including a processor and a memory, the server configured to:
generate a configurable data container that includes a first data field, the first data field corresponding to a first data path for retrieval of a first data value to be used in a first fraud detection rule, the configurable data container including a server-side schema and a client-side schema, each of the server-side schema and the client-side schema configured to validate a first input data value corresponding to the first data field,
export the configurable data container for use by the client-side device,
receive a modification to the configurable data container, the modification including a second data field to be associated with the configurable data container,
automatically bind the second data field to a second data path for retrieval of a second data value to be used in a second fraud detection rule,
generate an updated configurable data container, the updated configurable data container including an updated server-side schema and an updated client-side schema, each of the updated server-side schema and the updated client-side schema configured to validate a second input data value corresponding to the second data field, and
export the updated configurable data container for use by the client-side device.

2. The system of claim 1, wherein the server-side schema and the client-side schema are JavaScript Object Notation (“JSON”) schema.

3. The system of claim 1, wherein the updated configurable data container is stored as a new version of the configurable data container.

4. The system of claim 3, wherein a unique identification is used track changes made to the configurable data container from an original version of the configurable data container to the new version of the configurable data container.

5. The system of claim 1, wherein automatically binding the second data field to a second data path includes exposing the second data field to a fraud rule creation engine.

6. The system of claim 1, wherein the first data field and the second data field are selected from the group consisting of an address, a credit card number, a IP address, a user agent, a device identification, a device fingerprint, and an account.

7. The system of claim 1, wherein the configurable data container is accessible by a second client-side device.

8. The system of claim 7, wherein the updated configurable data container is not accessible by the second client-side device.

9. A computer-implemented fraud detection method, the method comprising:
generating a configurable data container that includes a first data field, the first data field corresponding to a first data path for retrieval of a first data value to be used in a first fraud detection rule, the configurable data container including a server-side schema and a client-side schema, each of the server-side schema and the client-side schema configured to validate a first input data value corresponding to the first data field;
exporting the configurable data container for use by a client-side device,
receiving a modification to the configurable data container, the modification including a second data field to be associated with the configurable data container;
automatically binding the second data field to a second data path for retrieval of a second data value to be used in a second fraud detection rule;
generating an updated configurable data container, the updated configurable data container including an updated server-side schema and an updated client-side schema, each of the updated server-side schema and the updated client-side schema configured to validate a second input data value corresponding to the second data field; and
exporting the updated configurable data container for use by the client-side device.

10. The method of claim 9, wherein the server-side schema and the client-side schema are JavaScript Object Notation (“JSON”) schema.

11. The method of claim 9, further comprising:
storing the updated configurable data container as a new version of the configurable data container.

12. The method of claim 11, further comprising:
tracking changes made to the configurable data container from an original version of the configurable data container to the new version of the configurable data container using a unique identification.

13. The method of claim 9, wherein automatically binding the second data field to a second data path includes exposing the second data field to a fraud rule creation engine.

14. The method of claim 9, wherein the first data field and the second data field are selected from the group consisting of an address, a credit card number, a IP address, a user agent, a device identification, a device fingerprint, and an account.

15. The method of claim 9, wherein the configurable data container is accessible by a second client-side device.

16. The method of claim 15, wherein the updated configurable data container is not accessible by the second client-side device.

17. A non-transitory computer readable medium including computer executable instructions stored in the computer readable medium for controlling a device to:
generate a configurable data container that includes a first data field, the first data field corresponding to a first data path for retrieval of a first data value to be used in a first fraud detection rule, the configurable data container including a server-side schema and a client-side schema, each of the server-side schema and the client-side schema configured to validate a first input data value corresponding to the first data field;
export the configurable data container for use by a client-side device;
receive a modification to the configurable data container, the modification including a second data field to be associated with the configurable data container;
automatically bind the second data field to a second data path for retrieval of a second data value to be used in a second fraud detection rule;
generate an updated configurable data container, the updated configurable data container including an updated server-side schema and an updated client-side schema, each of the updated server-side schema and the updated client-side schema configured to validate a second input data value corresponding to the second data field; and
export the updated configurable data container for use by the client-side device.

18. The non-transitory computer readable medium of claim 17, wherein the server-side schema and the client-side schema are JavaScript Object Notation (“JSON”) schema.

19. The non-transitory computer readable medium of claim 17, wherein the first data field and the second data field are selected from the group consisting of an address, a credit card number, a IP address, a user agent, a device identification, a device fingerprint, and an account.

20. The non-transitory computer readable medium of claim 17, wherein the updated configurable data container is stored as a new version of the configurable data container.
